(19) United States
(12) Patent Application Publication
(10) Pub. No.: US 2026/0188020 A1
(43) Pub. Date: Jul. 2, 2026

(54) ROAD SAFETY ASSISTANCE METHOD AND SYSTEM

(71) Applicant: COMPAL ELECTRONICS, INC., Taipei City (TW)

(72) Inventors: Hui-Wen Chan, Taipei City (TW); Li-Cheng Chiang, Taipei City (TW); Wei-Jun Wang, Taipei City (TW)

(73) Assignee: COMPAL ELECTRONICS, INC., Taipei City (TW)

(21) Appl. No.: 19/428,318

(22) Filed: Dec. 22, 2025

Related U.S. Application Data
(60) Provisional application No. 63/741,107, filed on Jan. 1, 2025.

(30) Foreign Application Priority Data
Nov. 4, 2025 (TW) 114142849

(51) Int. Cl. G06V 20/58; B60W 30/095; B60W 50/00; B60W 50/14; G06T 7/60; G06V 10/82; G06V 20/62

(52) U.S. Cl. CPC G06V 20/58; B60W 30/0956; B60W 50/0097; B60W 50/14; G06T 7/60; G06V 10/82; G06V 20/625; B60W 2420/403; B60W 2554/402; B60W 2554/4045; B60W 2556/20; G06T 2207/20081; G06T 2207/20084; G06T 2207/30261; G06V 2201/07; G06V 2201/08

(57) ABSTRACT

A road safety assistance method and system are provided. In the method, license plate information and wheel information of a neighboring vehicle are identified from an environmental image. Then, a vehicle type corresponding to the license plate information and the wheel information is determined, which includes comparing the license plate information with an encoding information, and comparing the wheel information with a specification information. The encoding information indicates a relationship between at least one of a numbering rule and a color of a license plate and a corresponding vehicle type, and the specification information indicates a relationship between at least one of a quantity, a size, a distribution, and a wheel distance of wheels and a corresponding vehicle type. Therefore, the accuracy of vehicle type identification is improved through dual information sources, so as to provide more reliable road safety assistance for a mobile vehicle.

### CROSS-REFERENCE TO RELATED APPLICATION

This application claims the priority benefit of U.S. provisional application Ser. No. 63/741,107, filed on Jan. 1, 2025 and Taiwan application serial no. 114142849, filed on Nov. 4, 2025. The entirety of each of the above-mentioned patent applications is hereby incorporated by reference herein and made a part of this specification.

### BACKGROUND

### Technical Field

The disclosure relates to a vehicle safety technology, and in particular relates to road safety assistance method and system.

### Description of Related Art

While the existing advanced driver-assistance systems (ADAS) are capable of providing forward collision warnings or lane departure alerts, they still exhibit significant limitations in identifying the specific types of neighboring vehicles. Most systems primarily rely on image contours or radar signals for object detection. Although this method may ascertain the presence of a vehicle, it struggles to accurately distinguish between different types of large vehicles, such as buses, dump trucks, or trailer trucks. However, different types of large vehicles have substantial differences in their turning blind spots, inner wheel differences, lateral wind pressure (i.e., turbulence) areas, and the blind spots in the field of view of the driver. When the system fails to accurately identify the vehicle type, the warnings it provides regarding hazardous areas may be inaccurate, rendering them ineffective in alerting the driver and, in some cases, potentially causing distractions due to erroneous alerts. Furthermore, a singular identification method (e.g., reliance solely on image contours) experiences a significant decrease in accuracy in adverse weather conditions, low lighting, or when the vehicle body is partially obscured, thereby affecting the overall reliability of the assistance system.

### SUMMARY

A road safety assistance method and system that may enhance the accuracy of vehicle type identification and provide more reliable hazard warnings are provided in the disclosure.

The road safety assistance system of this disclosure includes (but is not limited to) an image capturing device and a processor. The image capturing device is configured to capture an environmental image including a neighboring vehicle surrounding a mobile vehicle. The processor is coupled to the image capturing device and configured to perform the following operation. License plate information and wheel information of the neighboring vehicle are identified from the environmental image. A vehicle type corresponding to the license plate information and the wheel information is determined. The processor is further configured to compare the license plate information with encoding information, and to compare the wheel information with specification information. The encoding information indicates a relationship between at least one of a numbering rule of a license plate number and a license plate color and a corresponding vehicle type, and the specification information indicates a relationship between at least one of a quantity of wheels, a wheel size, a distribution, and a wheel distance and a corresponding vehicle type.

The road safety assistance method of this disclosure includes (but is not limited to) the following operation. License plate information and wheel information of the neighboring vehicle are identified from the environmental image. A vehicle type corresponding to the license plate information and the wheel information is determined. Determining the vehicle type includes comparing the license plate information with encoding information, and comparing the wheel information with specification information. The encoding information indicates a relationship between at least one of a numbering rule of a license plate number and a license plate color and a corresponding vehicle type, and the specification information indicates a relationship between at least one of a quantity of wheels, a wheel size, a distribution, and a wheel distance and a corresponding vehicle type.

Based on the above, the road safety assistance method and system of the disclosure may more accurately identify the specific vehicle type of a neighboring vehicle by integrating license plate information (e.g., color and numbering rule) and wheel information (e.g., quantity, size, and wheel distance) for dual comparison. Hereby, the deficiency in recognition capability may be overcome, thereby enabling the provision of more accurate predictions and warnings of hazardous areas based on the correct vehicle type. This significantly enhances the safety of mobile vehicles in complex road environments.

In order to make the above-mentioned features and advantages of the disclosure comprehensible, embodiments accompanied with drawings are described in detail below.

### BRIEF DESCRIPTION OF THE DRAWINGS

FIG. 1 is an element block diagram of a road safety assistance system according to an embodiment of the disclosure.

FIG. 2 is a flowchart of a road safety assistance method according to an embodiment of the disclosure.

FIG. 3 is a schematic diagram illustrating coordinate system mapping according to an embodiment of the disclosure.

FIG. 4A and FIG. 4B are schematic diagrams illustrating a scenario for identifying an appearance feature of a neighboring vehicle according to an embodiment of the disclosure.

FIG. 5 is a flowchart illustrating the determination of vehicle type according to an embodiment of the disclosure.

FIG. 6 is a schematic diagram illustrating license plate encoding information according to an embodiment of the disclosure.

FIG. 7 is a schematic diagram illustrating wheel information according to an embodiment of the disclosure.

FIG. 8A is a schematic diagram illustrating a scenario for identifying wheel information according to an embodiment of the disclosure.

FIG. 8B is a schematic diagram illustrating a scenario for identifying wheel information according to another embodiment of the disclosure.

FIG. 9 is a flowchart illustrating an alarm process based on a hazardous area parameter according to an embodiment of the disclosure.

FIG. 10A to FIG. 10C are schematic diagrams illustrating different hazardous areas according to an embodiment of the disclosure.

FIG. 11A and FIG. 11B are schematic diagrams illustrating a scenario for generating a virtual hazardous area according to an embodiment of the disclosure.

FIG. 11C is a flowchart illustrating the determination of a width of the virtual hazardous area according to an embodiment of the disclosure.

FIG. 11D is a schematic diagram illustrating the calculation of a width of the virtual hazardous area according to an embodiment of the disclosure.

FIG. 12 is a flowchart illustrating an alarm process based on a steering status of a neighboring vehicle according to an embodiment of the disclosure.

FIG. 13 is a schematic diagram illustrating a scenario for detecting the movement trajectory of a contact point according to an embodiment of the disclosure.

FIG. 14 is a flowchart illustrating model training according to an embodiment of the disclosure.

FIG. 15A and FIG. 15B are schematic diagrams illustrating a user feedback learning mechanism according to an embodiment of the disclosure.

FIG. 16 is a flowchart illustrating an alarm process based on a lateral target object according to an embodiment of the disclosure.

FIG. 17A is a schematic diagram illustrating a scenario for predicting lateral sudden hazard according to an embodiment of the disclosure.

FIG. 17B is a schematic diagram illustrating a scenario for predicting lateral sudden hazard according to another embodiment of the disclosure.

### DETAILED DESCRIPTION OF DISCLOSED EMBODIMENTS

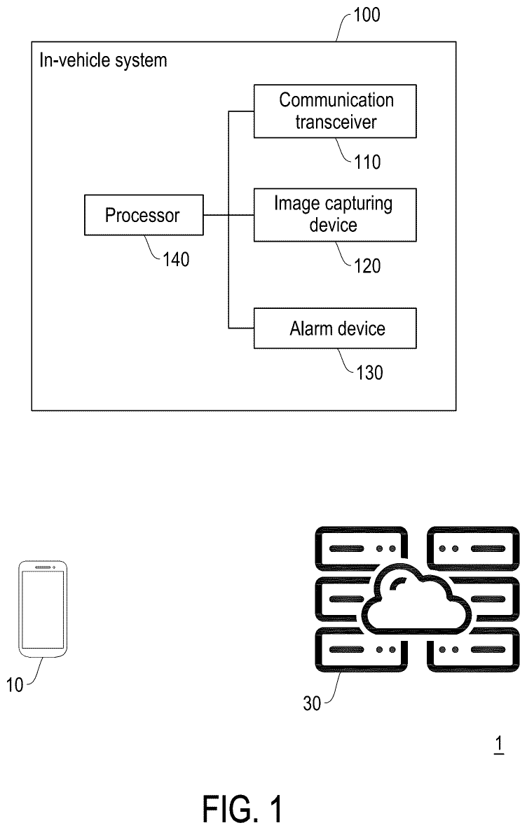

FIG. 1 is an element block diagram of a road safety assistance system 1 according to an embodiment of the disclosure. Referring to FIG. 1, the road safety assistance system 1 includes (but is not limited to) a terminal device 10, a server 30, and an in-vehicle system 100.

The terminal device 10 may be a smartphone, a tablet, a wearable device, a laptop, a smart assistant device, a smart home appliance or other electronic device with computing capabilities.

The server 30 may be a cloud server, a database server, or a server configured with specific functions.

The in-vehicle system 100 may be configured on a mobile vehicle. The mobile vehicle include, for example, a motorcycle, an electric bicycle, or any other two-wheeled or three-wheeled vehicle. The mobile vehicle may also be a car, a truck, a bus, or any other vehicle with four or more wheels. The in-vehicle system 100 includes (but is not limited to) a communication transceiver 110, an image capturing device 120, an alarm device 130, and a processor 140.

The transceiver 110 may be a module that supports Bluetooth, Wi-Fi, or cellular network (e.g., 4G, 5G) communication protocols. In one embodiment, the transceiver 110 is configured to wirelessly communicate with the server 30 or the terminal device 10, and to transmit or receive data accordingly.

The image capturing device 120 may be a wide-angle camera, fisheye camera, panoramic camera or other types of cameras with varying fields of view that is mounted at the front and/or rear of the mobile vehicle. In one embodiment, the image capturing device 120 is configured to capture environmental images including one or more neighboring vehicles surrounding the mobile vehicle. Neighboring vehicles refer to other vehicles, for example, motorcycles, cars, trucks, or lorries.

The alarm device 130 may be a buzzer, lights, a display, a vibration motor, a communication transceiver 110, or a combination thereof. In one embodiment, the alarm device 130 is configured to issue a warning message. This warning message may be sound (e.g., a buzzer or voice prompt), light (e.g., a warning light on the dashboard), vibration (e.g., a vibration motor mounted on the handlebars or seat), or a combination thereof.

The processor 140 is coupled to the communication transceiver 110, the image capturing device 120 and the alarm device 130 respectively. The processor 140 may be a central processing unit (CPU), a graphics processing unit (GPU), or other programmable general-purpose or special-purpose microprocessors, a digital signal processor (DSP), a programmable controller, a field programmable gate array (FPGA), an application-specific integrated circuit (ASIC), a neural network accelerator, or other similar components, or combinations of components thereof. In one embodiment, the processor 140 is configured to execute all or some of the operations of the in-vehicle system 100, and may load and execute various program code, software modules, files and data stored in the memory (not shown). In some embodiments, the functions of the processor 140 may be realized by software or chips.

In order to facilitate understanding of the operation process of the embodiments of the disclosure, the operation process of the embodiments of the disclosure will be described in detail with reference to a number of embodiments below. Hereinafter, the method described in the embodiment of the disclosure will be described with reference to the elements in FIG. 1.

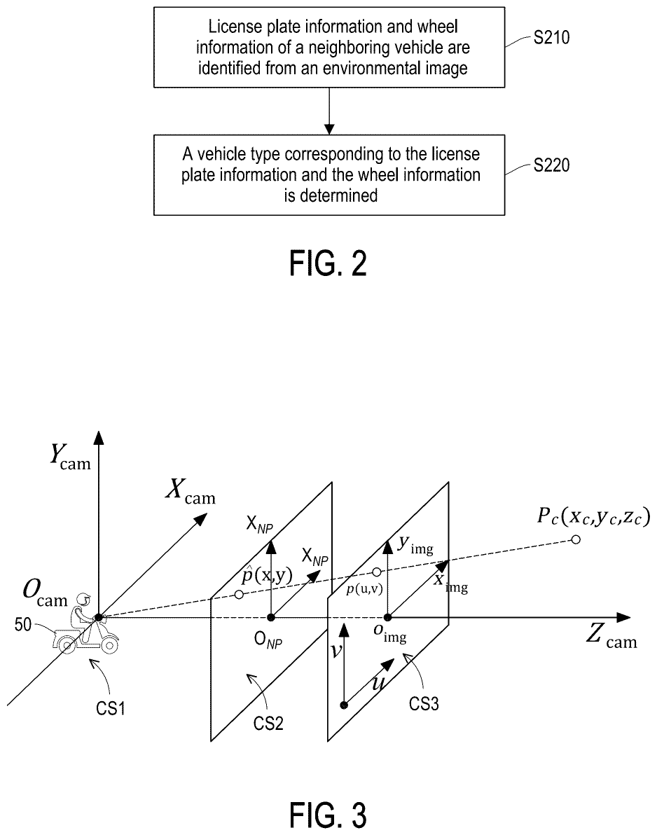

FIG. 2 is a flowchart of a road safety assistance method according to an embodiment of the disclosure. Referring to FIG. 2, the processor 140 identifies the license plate information and the wheel information of a neighboring vehicle from a environmental image (step S210). Specifically, the processor 140 continuously captures environmental images through the image capturing device 120. FIG. 3 is a schematic diagram illustrating coordinate system mapping according to an embodiment of the disclosure. Referring to FIG. 3, the processor 140 may establish the corresponding relationship between the three-dimensional (3D) coordinate points in the real world and the two-dimensional (2D) image pixels captured by the image capturing device 120 according to the basic projection principle of the pinhole camera model. This principle describes how a 3D coordinate point P_{c}(x_{c}, y_{c}, z_{c}) in the real world, after its light ray passes through the origin O_{cam} (i.e., the pinhole, corresponding to the position of the mobile vehicle 50) of a camera coordinate system CS1 (composed of the X_{cam}, Y_{cam}, and Z_{cam} axes), is projected onto a point \hat{p}(x,y) on a normalized imaging plane (coordinate system CS2, composed of the X_{NP} and Y_{NP} axes, with its origin O_{NP}). Finally, it forms a corresponding 2D pixel position p(u, v) on an object imaging plane (coordinate system CS3, composed of the x_{img} and y_{img} axes, with its origin O_{img}). Through the intrinsic and extrinsic parameters of a camera, bidirectional conversion between three-dimensional world coordinates and two-dimensional image coordinates may be performed.

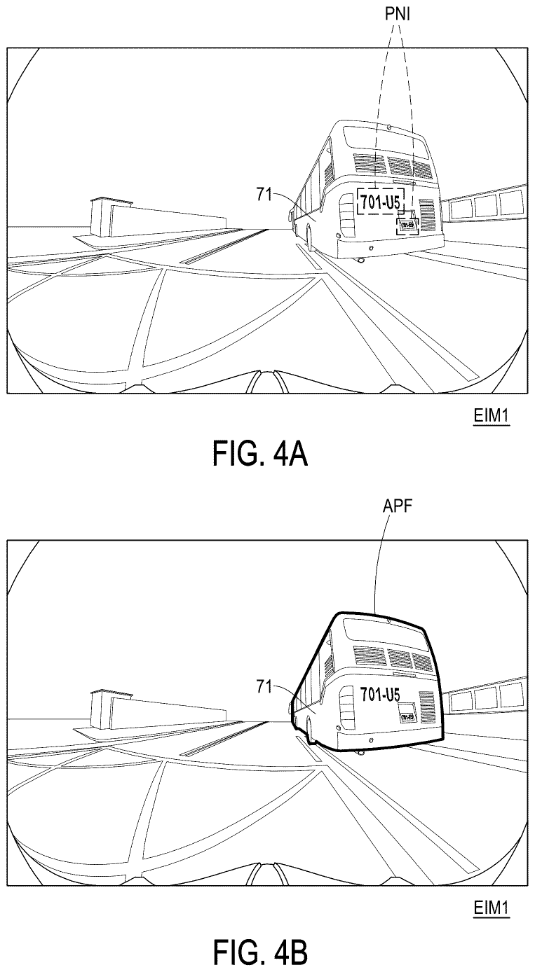

FIG. 4A and FIG. 4B are schematic diagrams illustrating a scenario for identifying an appearance feature of a neighboring vehicle according to an embodiment of the disclosure. Referring to FIG. 4A, the environmental image EIM1 includes an image of the neighboring vehicle 71 surrounding the mobile vehicle. The processor 140 analyzes multiple candidate areas in the image and selects the license plate area from the candidate areas. The processor 140 may determine that the license plate area is a valid license plate position, and further extract the corresponding license plate information PNI (e.g., indicating the license plate number “701-U5” of the neighboring vehicle 71) through optical character recognition (OCR) technology. In addition, the processor 140 may identify the color feature of the license plate area (i.e., the color of the license plate). At the same time, the processor 140 may also determine other areas within the image as noise points that are not license plates and exclude them accordingly.

Referring to FIG. 4B, on the other hand, the processor 140 may use image recognition technology (e.g., object detection model based on deep learning or comparison based on image features) to locate the position and the appearance feature (APF) of the neighboring vehicle 71 in the environmental image EIM1. The appearance feature APF may involve the size, contour, or shape of the neighboring vehicle 71.

In terms of identifying wheel information, the processor 140 may identify wheel-related feature from the image of the neighboring vehicle using image recognition technology (e.g., object detection model based on deep learning or comparison based on image features) as wheel information. In one embodiment, the wheel information may include a quantity of wheels, a wheel size, a wheel distance, a wheelbase, and/or a tire position.

Referring to FIG. 2, the processor 140 determines the vehicle type corresponding to the license plate information and wheel information (step S220). Specifically, in order to accurately determine the vehicle type of a neighboring vehicle (e.g., bus, truck, trailer trucks, etc.), embodiments of the disclosure integrate information from two different sources (i.e., license plate information and wheel information) for comprehensive judgment, which may greatly improve the accuracy and reliability of identification.

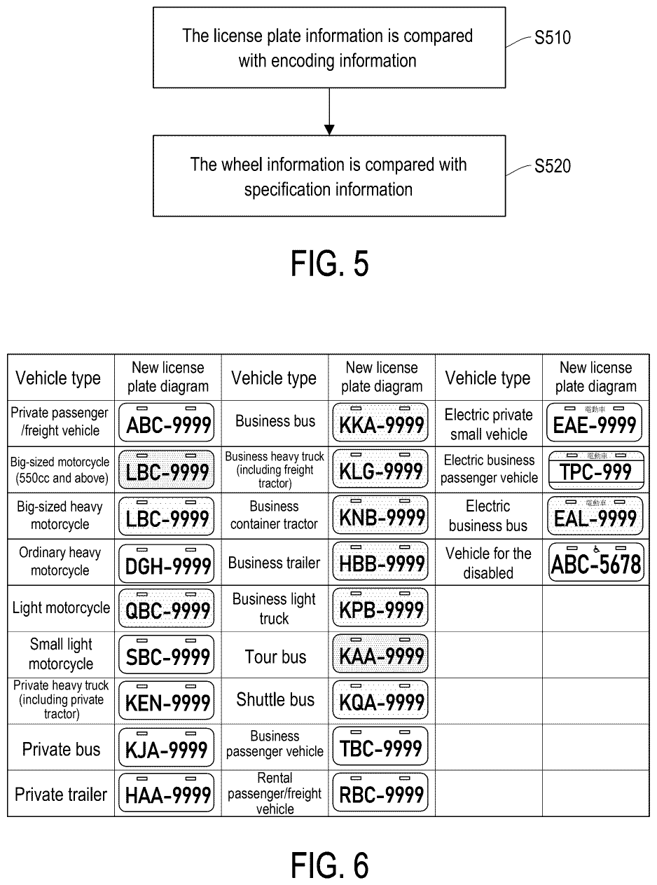

FIG. 5 is a flowchart illustrating the determination of vehicle type according to an embodiment of the disclosure. Referring to FIG. 5, the processor 140 compares the identified license plate information with the preset encoding information (step S510). The encoding information indicates the relationship between at least one of the numbering rule of a license plate number and a license plate color and the corresponding vehicle type. For example, FIG. 6 is a schematic diagram illustrating license plate encoding information according to an embodiment of the disclosure. Referring to FIG. 6, the encoded information may be stored in the memory of the in-vehicle system 100 or downloaded from the server 30. The encoding information may define the license plates of business buses (public buses) as a specific color combination (e.g., green background and white characters), while business trucks correspond to a different color combination. In addition, the encoding information may also define the numbering rule of license plate numbers, such as starting with a specific English letter (e.g., starting with K) and/or a specific number length (e.g., five digits) correspond to a specific vehicle type. The processor 140 may preliminarily determine the possible vehicle type of the neighboring vehicle by comparing the detected license plate information (license plate information PNI as shown in FIG. 4A) with this encoded information. Taking FIG. 4A as an example, the license plate information PNI corresponds to business bus.

On the other hand, the processor 140 may compare the identified wheel information with the preset specification information (step S520). Specifically, the specification information may also be pre-stored or downloaded remotely, and the content defines the wheel specifications for different vehicle types. For example, the specification information may indicate the corresponding relationship between features such as the quantity of wheels (e.g., two wheels, four wheels or more), size (e.g., diameter), distribution mode (e.g., single axle, dual axle or multi-axle arrangement), and wheel distance and a specific vehicle type (e.g., motorcycle, car, heavy truck or trailer truck). For example:
Two-wheeled vehicles (e.g., motorcycles): two small tires and a relatively short wheelbase. The wheelbase is between 1.1 and 2 meters. The wheelbase of a small motorcycle (e.g., a light motorcycle/scooter) is 1.1 meters, while the wheelbase of a heavy cruiser/chopper is 1.8 meters.
Four-wheeled vehicles: medium-sized tires, with a wheelbase between 2 and 3.5 meters.
Large vehicles (e.g., trailer trucks): multiple sets of large tires, wheelbase exceeding 3.5 meters, and may have 4 to 6 sets of tires.

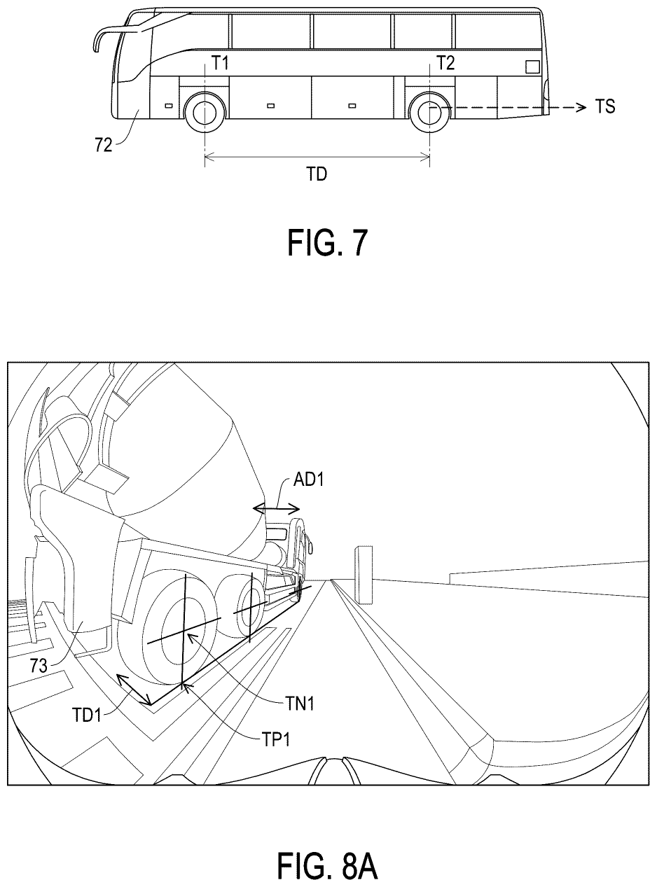

For example, FIG. 7 is a schematic diagram illustrating wheel information according to an embodiment of the disclosure. Referring to FIG. 7, the wheel information includes the quantity of wheels (e.g., two wheels on one side), wheel size TS, wheel distance TD (the lateral distance between two tires T1 and T2 on the same side), wheelbase (e.g., the horizontal distance between the centers of the front and rear sets of wheels), and tire position.

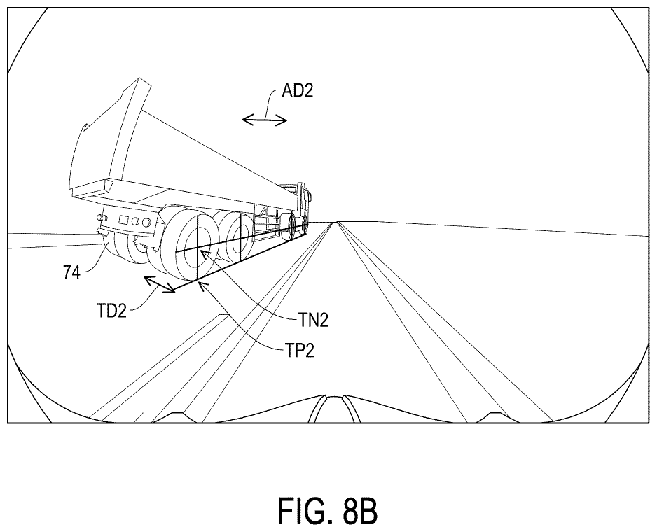

FIG. 8A is a schematic diagram illustrating a scenario for identifying wheel information according to an embodiment of the disclosure. Referring to FIG. 8A, the processor 140 may identify the quantity of wheels (TN1), wheel distance TD1, and wheelbase AD1 of the neighboring vehicle 73 (taking a cement truck as an example). FIG. 8B is a schematic diagram illustrating a scenario for identifying wheel information according to another embodiment of the disclosure. Referring to FIG. 8B, the processor 140 may identify the quantity of wheels (TN2), wheel distance TD2, and wheelbase AD2 of the neighboring vehicle 74 (taking a truck as an example).

By comparing the wheel information, the processor 140 may obtain a second criterion regarding the type of the neighboring vehicle, which may then be cross-verified with the comparison result of the license plate information to produce a more reliable identification result.

The processor 140 may combine these two comparison results to determine the final vehicle type of the neighboring vehicle. In one embodiment, the processor 140 may set confidence scores for the two comparison results respectively. For example, if the detected license plate information is clear and complete, the corresponding confidence score is higher; conversely, if the license plate is obscured or blurry, the confidence score is lower. Similarly, if multiple wheel features of the neighboring vehicle may be clearly identified, the confidence score for the wheel information will also be higher. The processor 140 may determine the most reliable vehicle type according to preset logic (e.g., adopting the result with the higher confidence score, or confirming the vehicle type when both are high and the results are consistent). In another embodiment, the processor 140 may directly input the two comparison results into a trained artificial intelligence model, and the artificial intelligence model may infer the final vehicle type of the neighboring vehicle. This artificial intelligence model has been trained to understand the relationships or associations between license plate information, wheel information, and vehicle type.

After accurately determining the vehicle type of the neighboring vehicle, embodiments of the disclosure may further provide more precise hazard warnings to the driver of the mobile vehicle based on this specific vehicle type.

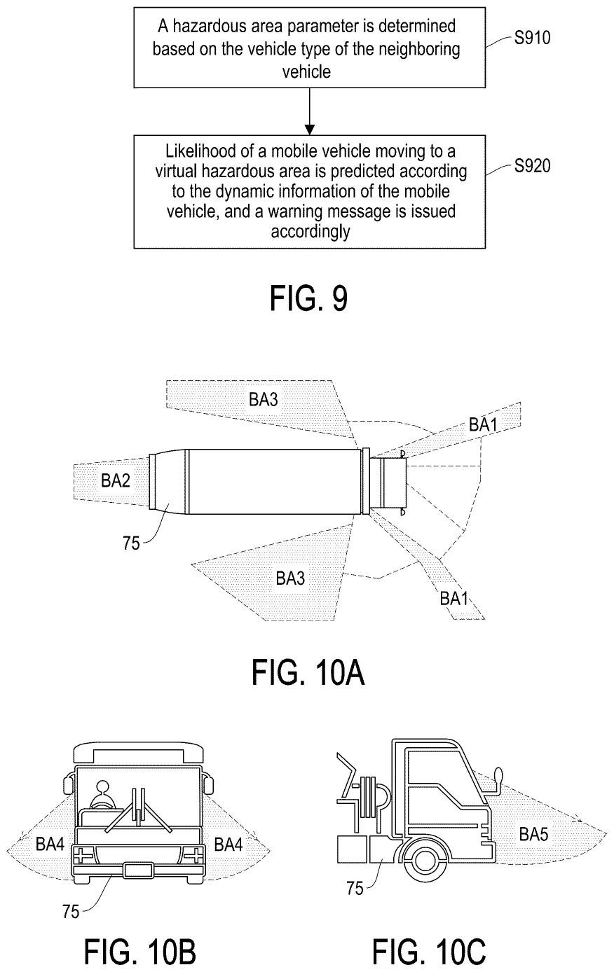

FIG. 9 is a flowchart illustrating an alarm process based on a hazardous area parameter according to an embodiment of the disclosure. Referring to FIG. 9, the processor 140 may determine a hazardous area parameter according to the vehicle type of the neighboring vehicle (step S910). Specifically, the hazardous area parameter indicates the position and size of one or more virtual hazardous areas extending from the position of the neighboring vehicle. Different types of vehicles (especially large vehicles) have different hazardous area features. In one embodiment, the processor 140 may read from memory or download from the server 30 the (preset) hazardous area parameter corresponding to a specific vehicle type.

FIG. 10A to FIG. 10C are schematic diagrams illustrating different hazardous areas according to an embodiment of the disclosure. Referring to FIG. 10A to FIG. 10C, the hazardous area parameter may further indicate different types of hazardous areas. For example, FIG. 10A illustrates the front turning blind spot BA1, the rear view blind spot range BA2, and the vehicle lateral turbulence area range BA3 surrounding the neighboring vehicle 75. FIG. 10B illustrates the inner wheel difference blind spot BA4 that may be formed when the neighboring vehicle 75 is making a turn. FIG. 10C illustrates the forward blind spot BA5 of the neighboring vehicle 75 when it is in motion. The length, width, and shape of these hazardous areas may all be predefined and associated with specific vehicle types.

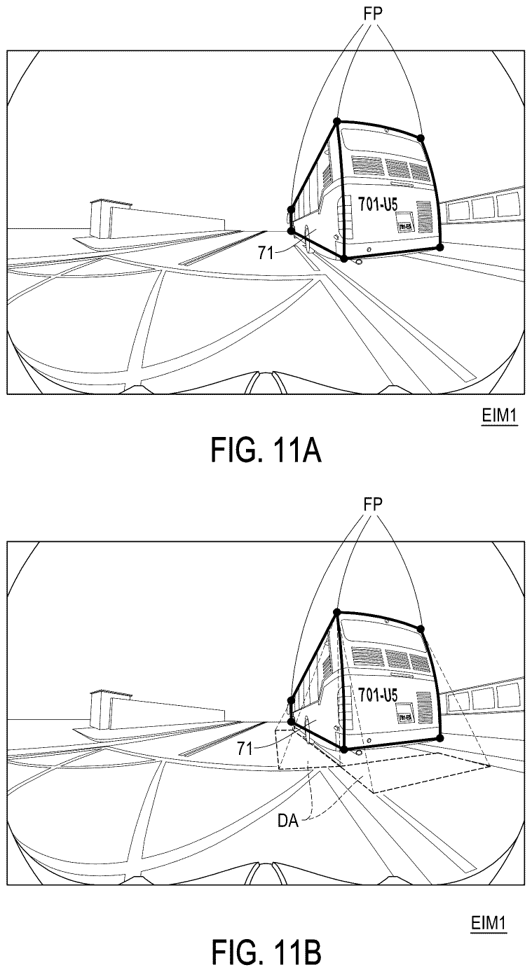

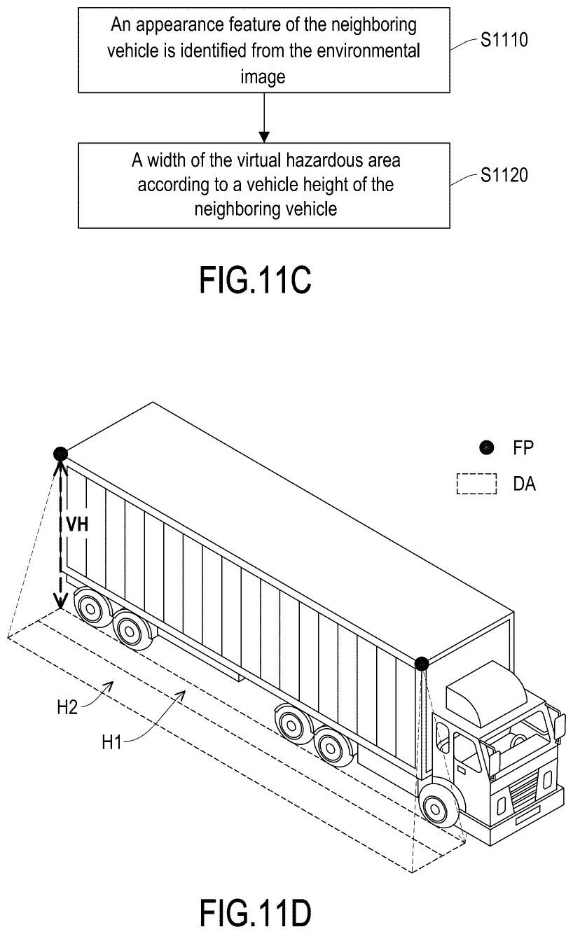

The processor 140 may refer to these hazardous area parameters to set the position and size of the virtual hazardous area. For example, FIG. 11A and FIG. 11B are schematic diagrams illustrating a scenario for generating a virtual hazardous area according to an embodiment of the disclosure. Referring to FIG. 11A, the processor 140 identifies the vertex FP from the vehicle body contour. Next, referring to FIG. 11B, the processor 140 uses a geometric projection method to transform the vertex FP to the road coordinate system to generate a virtual hazardous area DA that dynamically changes as the neighboring vehicle 76 moves.

Referring to FIG. 9, the processor 140 may predict the likelihood of the mobile vehicle moving to a hazardous area according to the dynamic information of the mobile vehicle, and issue a warning message accordingly (step S920). Specifically, the processor 140 continuously monitors the speed, direction, and predicted path of its respective mobile vehicle, and simultaneously calculates the real-time position of the virtual hazardous area generated by the neighboring vehicle in the world coordinate system. When the processor 140 determines that the predicted path of the mobile vehicle will overlap with or be too close to any virtual hazardous area (e.g., less than a distance threshold), it will activate the alarm device 130 to issue a warning to alert the driver to potential risks.

FIG. 11C is a flowchart illustrating the determination of a width of the virtual hazardous area according to an embodiment of the disclosure. Referring to FIG. 11C, the processor 140 may identify an appearance feature of neighboring vehicle from the environmental image (step S1110). FIG. 11D is a schematic diagram illustrating the calculation of a width of the virtual hazardous area according to an embodiment of the disclosure. Referring to FIG. 11D, the appearance feature further indicate the vehicle height VH of the neighboring vehicle 71. As shown in FIG. 11A, the processor 140 may identify several vertices FP of the neighboring vehicle 71 and then calculate the distance between two vertices FP corresponding to the vehicle height VH.

Referring to FIG. 11C, the processor 140 may determine a width of the virtual hazardous area according to the vehicle height of the neighboring vehicle (step S1120). Taking FIG. 11D as an example, the width of this virtual hazardous area may be dynamically adjusted according to the vehicle height VH. The widths H1 and H2 of the virtual hazardous area DA may be proportional to the vehicle height VH. For example, the width H1 is 0.263 times the vehicle height VH, while the width H2 is 0.526 times the vehicle height VH. However, the mathematical relationship between width and vehicle height is not limited to the above example.

In addition, the virtual hazardous area corresponding to the width H1 is adjacent to the vehicle body of the neighboring vehicle 76 and considered to be a high hazardous area. The virtual hazardous area DA corresponding to width H2 is farther from the vehicle body of the neighboring vehicle 76 and considered to be a more peripheral potential attention area. The processor 140 may provide different levels of alerts for these two areas. For example, when a mobile vehicle enters the more peripheral virtual hazardous area DA corresponding to width H2, the alarm device 130 may only issue a visual warning message. However, if the mobile vehicle continues to approach and enters the virtual hazardous area DA corresponding to width H1 adjacent to the side of the vehicle, the alarm device 130 may activate a more intense warning message, such as sound plus vibration, to alert the driver to take evasive action immediately. This allows for the provision of more accurate virtual hazardous areas that more closely resemble real physical conditions, and enhances the reliability of tiered warning effects.

It is worth noting that the processor 140 may establish a three-dimensional world coordinate system to determine the relative position of the mobile vehicle and the virtual hazardous area. As shown in FIG. 3, in coordinate system CS1, the position of the mobile vehicle 50 may be regarded as the origin O_{cam}, and its driving direction may be defined as one of the axes (e.g., the Z_{cam} axis). As explained above, by using the projection principle of the pinhole camera model, the feature points of the neighboring vehicle (e.g., the center of the license plate and the vertices of the vehicle body) may be mapped from the two-dimensional image to this three-dimensional world coordinate system, thereby obtaining the precise 3D position of the neighboring vehicle in the real world. Since the virtual hazardous area is generated by the vehicle body of the neighboring vehicle, the coordinates of all the vertices of this virtual hazardous area (which may be defined as a polygon or solid in a 3D space) are also defined in this unified world coordinate system. Since both the “mobile vehicle 50” (a point) and the “virtual hazardous area” (a polygon in space) have coordinates in the same coordinate system, the processor 140 may easily use standard geometric operations to calculate the shortest distance (e.g., Euclidean distance) between them. By comparing the coordinates of the “virtual hazardous area” with the coordinates of the “mobile vehicle”, the processor 140 may also determine the relative position of the neighboring vehicle or the virtual hazardous area. For example, if the coordinates of the virtual hazardous area are mainly distributed in the positive direction of the Z_{cam} axis of the mobile vehicle, it is determined to be located in the front; if they are distributed in the positive direction of the X_{cam} axis, it is located on the left, and so on. Vector analysis allows for a more precise determination of the direction from which a virtual hazardous area approaches.

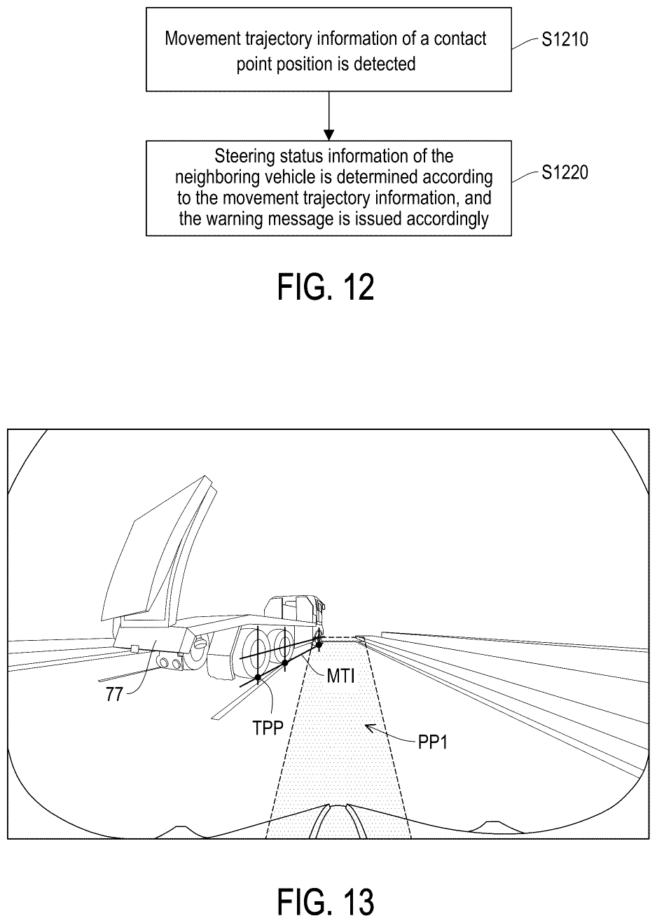

Furthermore, embodiments of the disclosure may also detect the dynamic behavior of the neighboring vehicle to provide real-time warnings. In one embodiment, the wheel information may further indicate the contact point position between the wheels of a neighboring vehicle and the ground. FIG. 12 is a flowchart illustrating an alarm process based on a steering status of a neighboring vehicle according to an embodiment of the disclosure. Referring to FIG. 12, the processor 140 may detect the movement trajectory of the contact point position (step S1210). Specifically, FIG. 13 is a schematic diagram illustrating a scenario for detecting the movement trajectory of a contact point according to an embodiment of the disclosure. Referring to FIG. 13, the processor 140 may track the trajectory of the contact point position TPP of the tires of the neighboring vehicle 77 changing over time through continuous environmental images, and record this as the movement trajectory information MTI (e.g., recording the position of the contact point position TPP at multiple time points).

Referring to FIG. 12, the processor 140 may determine the steering status information of the neighboring vehicle according to the movement trajectory information, and issue the warning message accordingly (step S1220). Specifically, the processor 140 may analyze the changing trends of movement trajectory information (e.g., the curvature or direction of the trajectory) to determine whether a neighboring vehicle is turning or changing lanes (i.e., steering status information). As shown in FIG. 13, if the processor 140 determines that the steering state of the neighboring vehicle 77 will cause the driving path corresponding to the movement trajectory information to intersect with the predicted path PP1 of its respective mobile vehicle, it will drive the alarm device 130 to issue a warning message.

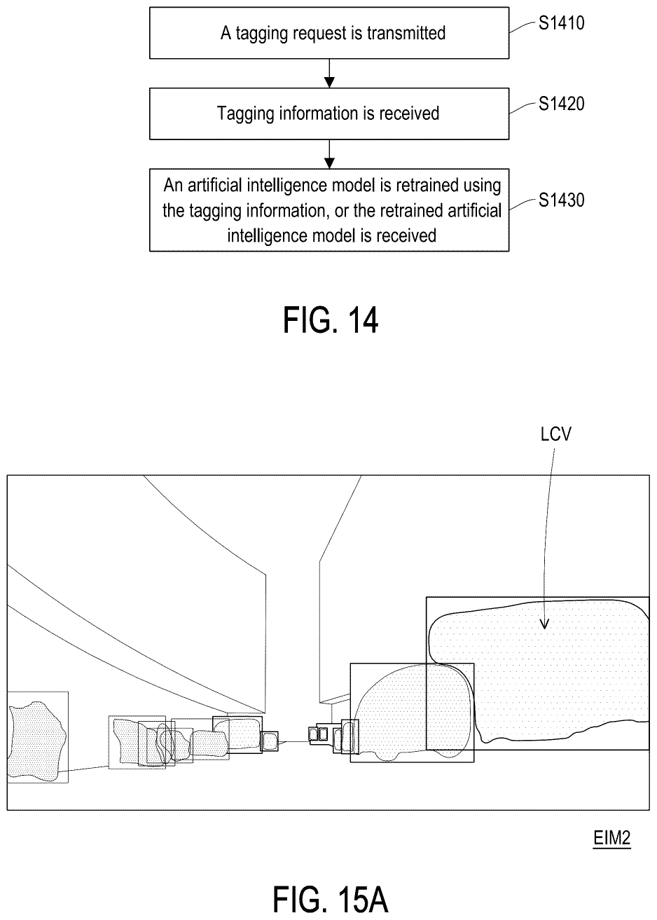

To continuously improve the accuracy of vehicle type identification, this disclosure further proposes a learning mechanism based on user feedback. FIG. 14 is a flowchart illustrating model training according to an embodiment of the disclosure. Referring to FIG. 14, the processor 140 may transmit a tagging request (step S1410). In one embodiment, when the processor 140 identifies the vehicle type of an unknown vehicle through an artificial intelligence model, if the confidence score it generates is lower than a preset threshold (e.g., 40%, 50%, or 60%), the processor 140 may transmit a tagging request, which includes the image of the unknown vehicle, to the terminal device 10 or the server 30 through the communication transceiver 110 to request manual tagging.

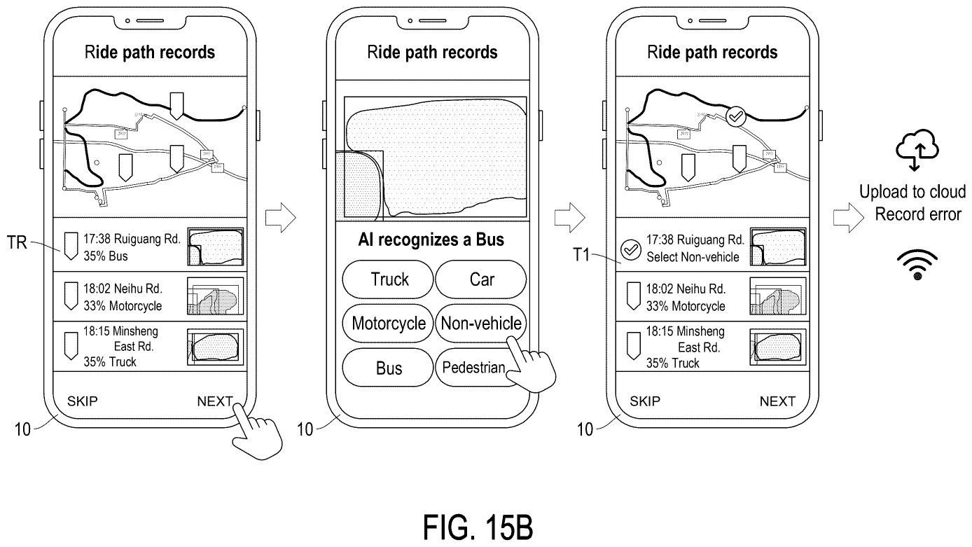

FIG. 15A and FIG. 15B are schematic diagrams illustrating a user feedback learning mechanism according to an embodiment of the disclosure. Referring to FIG. 15A, when the in-vehicle system 100 has a low confidence value LCV (e.g., the confidence in identifying a bus is only 35%) for the identification result of objects in the environmental image EIM2, the in-vehicle system 100 generates a tagging request. This tagging request TR may be displayed on the user interface of terminal device 10 as shown in FIG. 15B, and provides multiple vehicle type options for the user to select.

Referring to FIG. 14, the in-vehicle system 100 receives the tagging information (step S1420). This tagging information is the vehicle type tag feedback provided by the user through the terminal device 10. Next, the processor 140 may use this tagging information to retrain the built-in artificial intelligence model (step S1430) to optimize its recognition capabilities. In another embodiment, the tagging information may also be uploaded to the server 30 for batch training. After completion, the in-vehicle system 100 receives the retrained new version of the artificial intelligence model through the communication transceiver 110.

In this embodiment of the disclosure, “artificial intelligence model” refers to a type of model constructed through mathematical and computational methods that may learn from data and execute specific intelligent tasks. The core of this artificial intelligence model is that it does not directly specify all rules through traditional programming, but rather learns implicit patterns and relationships from a large amount of example data through a “training” process. The artificial intelligence model in this embodiment of the disclosure may be configured to execute tasks such as image recognition and object detection, and its specific functions may include:
Object detection and localization: objects of interest, such as neighboring vehicles, license plates, wheels, pedestrians, or vehicle doors, are accurately selected from complex environmental images captured by the image capturing device 120.
Feature extraction: from the detected objects, key feature information, such as characters on the license plate, the quantity and size of the wheels, or the contour of the vehicle, are further extracted.
Object classification: objects are classified into predefined categories according to the extracted features, such as determining the specific vehicle type of a neighboring car as “bus”, “truck” or “passenger car”.

To achieve the above functions, this artificial intelligence model may be (but is not limited to) any one or a combination of the following:
Deep learning models: in particular, convolutional neural networks (CNNs), with their distinctive multi-layer structure, exhibit exceptional performance in processing image data. They are particularly well-suited for object detection and feature extraction tasks of this disclosure.
Examples include YOLO (you only look once) and SSD (single shot multibox detector).
Traditional machine learning models: for example, support vector machines (SVM) and decision trees, these models may be employed for the final classification of vehicle types once features (e.g., the quantity of wheels and the color code of the license plate) have been preliminarily extracted.

Before deployment, this artificial intelligence model is trained offline using a dataset containing a large amount of tagged images. After being deployed to the in-vehicle system 100, it may conduct online retraining or iterative updates of the model by receiving user feedback and tagging information, so that its recognition ability may continue to evolve to adapt to more diverse road scenarios.

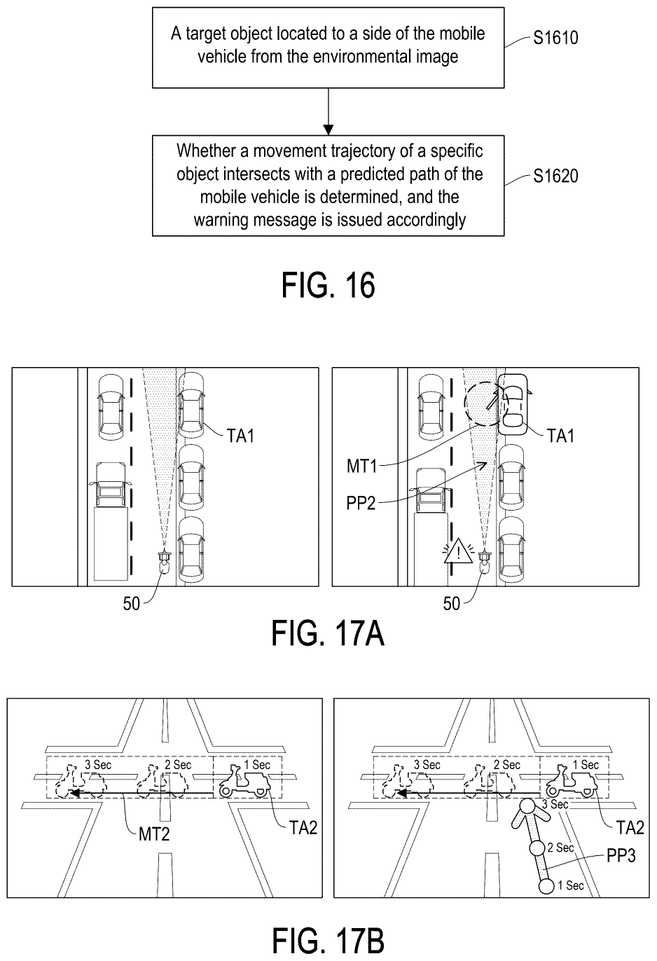

In addition to identifying and warning of neighboring vehicles in the front or adjacent lanes, embodiments of the disclosure may also detect sudden hazards from the side of mobile vehicle. FIG. 16 is a flowchart illustrating an alarm process based on a lateral target object according to an embodiment of the disclosure. Referring to FIG. 16, the processor 140 may detect a target object located to the side of the mobile vehicle from the environmental image (step S1610). For example, a target object may be identified using image recognition techniques (e.g., object detection model based on deep learning or comparison based on image features). The type of target object could be a vehicle, a pedestrian, or an animal. FIG. 17A is a schematic diagram illustrating a scenario for predicting lateral sudden hazard according to an embodiment of the disclosure. FIG. 17B is a schematic diagram illustrating a scenario for predicting lateral sudden hazard according to another embodiment of the disclosure. Referring to FIG. 17A and FIG. 17B, this target object may be a static hazard (e.g., the door of a parked vehicle TA1 suddenly opening as shown in FIG. 17A) or a dynamic hazard (e.g., a motorcycle TA2 suddenly appearing from an alleyway or roadside and moving laterally as shown in FIG. 17B, but it could also be a pedestrian, an animal, or other vehicles).

Referring to FIG. 16, after detecting a lateral target object, the processor 140 may determine whether the target object intersects with the predicted path of the mobile vehicle according to its movement trajectory, and issue the warning message accordingly (step S1620). Taking FIG. 17A as an example, the processor 140 may predict the final opening range of the opening door (i.e., the movement trajectory MT1) and determine whether it will enter the driving path PP2 of the mobile vehicle 50 in the next few seconds. Alternatively, taking FIG. 17B as an example, the processor 140 may predict the movement path (i.e., the movement trajectory MT2) of the laterally moving motorcycle TA2 and determine whether it will enter the driving path PP3 of this mobile vehicle in the next few seconds. If it is determined that there will be an intersection (e.g., the driving path intersects with the movement trajectory), the processor 140 will drive the alarm device 130 to allow time for the driver to react.

To sum up, the road safety assistance method and system of this disclosure may significantly improve the accuracy of identifying the type of a neighboring vehicle (especially a large vehicle) by integrating license plate information and wheel information for dual comparison. Based on this accurate identification result, the embodiments of the disclosure may further generate dynamic virtual hazardous areas corresponding to the vehicle type and the vehicle height. By integrating real-time detection of the steering intentions of the neighboring vehicle, it provides drivers with more context-aware warnings. Furthermore, by introducing a user feedback learning mechanism and a detection function for sudden lateral hazards, the embodiments of the disclosure may not only continuously optimize its own identification model, but also extend the protection range from the front to the side, thereby constructing a more comprehensive, reliable and self-evolving road safety assistance solution.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A road safety assistance system, comprising:
an image capturing device, configured to capture an environmental image comprising a neighboring vehicle surrounding a mobile vehicle; and
a processor, coupled to the image capturing device and configured to:
identify license plate information and wheel information of the neighboring vehicle from the environmental image, wherein the license plate information indicates a license plate number of the neighboring vehicle; and
determine a vehicle type corresponding to the license plate information and the wheel information, comprising:
comparing the license plate information with encoding information, wherein the encoding information indicates a relationship between at least one of a numbering rule of a license plate number and a license plate color and a corresponding vehicle type; and
comparing the wheel information with specification information, wherein the specification information indicates a relationship between at least one of a quantity of wheels, a wheel size, a distribution, and a wheel distance and a corresponding vehicle type.

2. The road safety assistance system according to claim 1, wherein the processor is further configured to:
determine a hazardous area parameter according to the vehicle type corresponding to the neighboring vehicle, wherein the hazardous area parameter indicates a position and size of at least one virtual hazardous area extending from a position of the neighboring vehicle; and
predict likelihood of the mobile vehicle moving to the at least one virtual hazardous area according to dynamic information of the mobile vehicle, and issue a warning message accordingly.

3. The road safety assistance system according to claim 2, wherein the hazardous area parameter further indicates:
a length and a width of a front turning blind spot;
a rear view blind spot range; and/or
a vehicle lateral turbulence area range.

4. The road safety assistance system according to claim 2, wherein the processor is further configured to:
identify an appearance feature of the neighboring vehicle from the environmental image, wherein the appearance feature indicates a vehicle height of the neighboring vehicle; and
determine a width of the at least one virtual hazardous area according to the vehicle height of the neighboring vehicle.

5. The road safety assistance system according to claim 1, further comprising:
a communication transceiver, coupled to the processor and configured to:
transmit a tagging request, wherein the tagging request is configured to query the vehicle type of an unknown vehicle, wherein a confidence score in determining the corresponding vehicle type for the unknown vehicle is lower than a corresponding threshold; and
receive tagging information, wherein the tagging information indicates the vehicle type of the unknown vehicle, and the processor is further configured to:
retrain an artificial intelligence model using the tagging information, wherein the artificial intelligence model is configured to determine the vehicle type of the neighboring vehicle; or
receive the retrained artificial intelligence model through the communication transceiver.

6. The road safety assistance system according to claim 1, wherein the wheel information further indicates at least one contact point position between wheels of the neighboring vehicle and a ground, and the processor is further configured to:
detect movement trajectory information of the at least one contact point position, wherein the movement trajectory information indicates a trajectory of the at least one contact point position changing over time; and
determine steering status information of the neighboring vehicle according to the movement trajectory information, and issue a warning message accordingly.

7. The road safety assistance system according to claim 1, wherein the processor is further configured to:
detect a target object located to a side of the mobile vehicle from the environmental image, wherein the target object is an opening door or a laterally moving object; and
determine whether the target object intersects with a predicted path of the mobile vehicle according to a movement trajectory of the target object, and issue a warning message accordingly.

8. A road safety assistance method, comprising:
identifying license plate information and wheel information of a neighboring vehicle from an environmental image, wherein the environmental image comprises the neighboring vehicle surrounding a mobile vehicle, the license plate information indicates a license plate number of the neighboring vehicle; and
determining a vehicle type corresponding to the license plate information and the wheel information, comprising:
comparing the license plate information with encoding information, wherein the encoding information indicates a relationship between at least one of a numbering rule of a license plate number and a license plate color and a corresponding vehicle type; and
comparing the wheel information with specification information, wherein the specification information indicates a relationship between at least one of a quantity of wheels, a wheel size, a distribution, and a wheel distance and a corresponding vehicle type.

9. The road safety assistance method according to claim 8, further comprising:
determining a hazardous area parameter according to the vehicle type corresponding to the neighboring vehicle, wherein the hazardous area parameter indicates a position and size of at least one virtual hazardous area extending from a position of the neighboring vehicle; and
predicting likelihood of the mobile vehicle moving to the at least one virtual hazardous area according to dynamic information of the mobile vehicle, and issuing a warning message accordingly.

10. The road safety assistance method according to claim 9, wherein the hazardous area parameter further indicates:
a length and a width of a front turning blind spot;
a rear view blind spot range; and/or
a vehicle lateral turbulence area range.

11. The road safety assistance method according to claim 9, further comprising:
identifying an appearance feature of the neighboring vehicle from the environmental image, wherein the appearance feature indicates a vehicle height of the neighboring vehicle; and
determining a width of the at least one virtual hazardous area according to the vehicle height of the neighboring vehicle.

12. The road safety assistance method according to claim 8, further comprising:
transmitting a tagging request, wherein the tagging request is configured to query the vehicle type of an unknown vehicle, wherein a confidence score in determining the corresponding vehicle type for the unknown vehicle is lower than a corresponding threshold; and
receiving tagging information, wherein the tagging information indicates the vehicle type of the unknown vehicle; and
retraining an artificial intelligence model using the tagging information, or receiving the retrained artificial intelligence model, wherein the artificial intelligence model is configured to determine the vehicle type of the neighboring vehicle.

13. The road safety assistance method according to claim 8, wherein the wheel information further indicates at least one contact point position between wheels of the neighboring vehicle and a ground, and the road safety assistance method further comprises:
detecting movement trajectory information of the at least one contact point position, wherein the movement trajectory information indicates a trajectory of the at least one contact point position changing over time; and
determining steering status information of the neighboring vehicle according to the movement trajectory information, and issuing a warning message accordingly.

14. The road safety assistance method according to claim 8, further comprising:
detecting a target object located to a side of the mobile vehicle from the environmental image, wherein the target object is an opening door or a laterally moving object; and
determining whether the target object intersects with a predicted path of the mobile vehicle according to a movement trajectory of the target object, and issuing a warning message accordingly.
